(19) United States
(12) Patent Application Publication
(10) Pub. No.: US 2025/0109964 A1
(43) Pub. Date: Apr. 3, 2025

(54) MAP GENERATION DEVICE AND MAP GENERATION METHOD

(71) Applicant: JVCKENWOOD Corporation, Yokohama-shi (JP)

(72) Inventor: Yasutoshi Sakai, Yokohama-shi (JP)

(21) Appl. No.: 18/978,030

(22) Filed: Dec. 12, 2024

Related U.S. Application Data
(63) Continuation of application No. PCT/JP2023/023263, filed on Jun. 23, 2023.

(30) Foreign Application Priority Data
Jun. 27, 2022 (JP) 2022-102720

(51) Int. Cl. G01C 21/00; G01B 21/16

(52) U.S. Cl. CPC G01C 21/3841; G01B 21/16

(57) ABSTRACT

A map generation device includes an information acquisition unit that acquires positional information on a specific vehicle and positional information on a surrounding vehicle that is positioned around the specific vehicle from on-board devices that are arranged respectively on the specific vehicle and the surrounding vehicle, respectively; a distance calculator that calculates a distance between the specific vehicle and the surrounding vehicle based on the positional information on the specific vehicle and the positional information on the surrounding vehicle; an integration area setting unit that sets an integration area of integration into a map based on a result of calculating the distance and an area of detection by the specific vehicle; and a map integration unit that integrates the positional information on the surrounding object that is acquired from the on-board device in the integration area into a map.

### CROSS-REFERENCE TO RELATED APPLICATION

This application is a Continuation of PCT International Application No. PCT/JP2023/023263 filed on Jun. 23, 2023 which claims the benefit of priority from Japanese Patent Application No. 2022-102720 filed on Jun. 27, 2022, the entire contents of both of which are incorporated herein by reference.

### BACKGROUND OF THE INVENTION

### 1. Field of the Invention

The present disclosure relates to a map generation device and a map generation method.

### 2. Description of the Related Art

A technology of generating a map based on images that are captured by image capturing devices mounted on vehicles has been known. Japanese Laid-open Patent Publication No. 2020-197708 discloses a technology of generating a map by performing weighting based on imbalance in data of images that are transmitted from image capturing devices and integrating the data.

According to the technology according to Japanese Laid-open Patent Publication No. 2020-197708, when vehicles are packed densely, there is a possibility determination on weighting in integrating data will be complicated because images of the same object are captured at a time from a large number of vehicles.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A map generation device according to the present disclosure comprising: an information acquisition unit that acquires positional information on a specific vehicle and positional information on a surrounding vehicle that is positioned around the specific vehicle from on-board devices that are arranged respectively on the specific vehicle and the surrounding vehicle, respectively; a distance calculator that calculates a distance between the specific vehicle and the surrounding vehicle based on the positional information on the specific vehicle and the positional information on the surrounding vehicle; an integration area setting unit that sets an integration area of integration into a map based on a result of calculating the distance and an area of detection by the specific vehicle; and a map integration unit that integrates an information on the surrounding object that is acquired from the on-board device in the integration area into a map.

A map generation method according to the present disclosure comprising: acquiring positional information on a specific vehicle and positional information on a surrounding vehicle that is positioned around the specific vehicle from on-board devices that are arranged respectively on the specific vehicle and the surrounding vehicle, respectively; calculating a distance between the specific vehicle and the surrounding vehicle based on the positional information on the specific vehicle and the positional information on the surrounding vehicle; setting an integration area of integration into a map based on a result of calculating the distance and an area of detection by the specific vehicle; and integrating an information on the surrounding object that is acquired from the on-board device in the integration area into a map.

### BRIEF DESCRIPTION OF THE DRAWINGS

FIG. 1 is a diagram for describing an example of a configuration of a map generation system according to a first embodiment;

FIG. 2 is a block diagram illustrating an example of a configuration of an on-board device according to the first embodiment;

FIG. 3 is a diagram illustrating an example of a configuration of a map generation device according to the first embodiment;

FIG. 4 is a flowchart illustrating a flow of a map generation process according to the first embodiment;

FIG. 5 is a diagram for describing a method of acquiring positional information on vehicles according to the first embodiment;

FIG. 6 is a diagram for describing a method of setting an integration area according to the first embodiment;

FIG. 7 is a diagram for describing a method of integrating a surrounding object in the integration area into a map according to the first embodiment;

FIG. 8 is a block diagram illustrating an example of a configuration of a map generation device according to a second embodiment;

FIG. 9 is a flowchart illustrating a flow of a reliability determination process performed by an on-board device according to the second embodiment;

FIG. 10 is a diagram for describing a method of acquiring vehicle information according to the second embodiment; and

FIG. 11 is a flowchart illustrating a flow of a map generation process according to the second embodiment.

### DETAILED DESCRIPTION OF THE PREFERRED EMBODIMENTS

With reference to the accompanying drawings, embodiments according to the present disclosure will be described in detail below. Note that the embodiments do not limit the present disclosure and, in the following embodiments, the same parts are denoted with the same reference numerals and thus redundant description will be omitted.

### First Embodiment

### Map Generation System

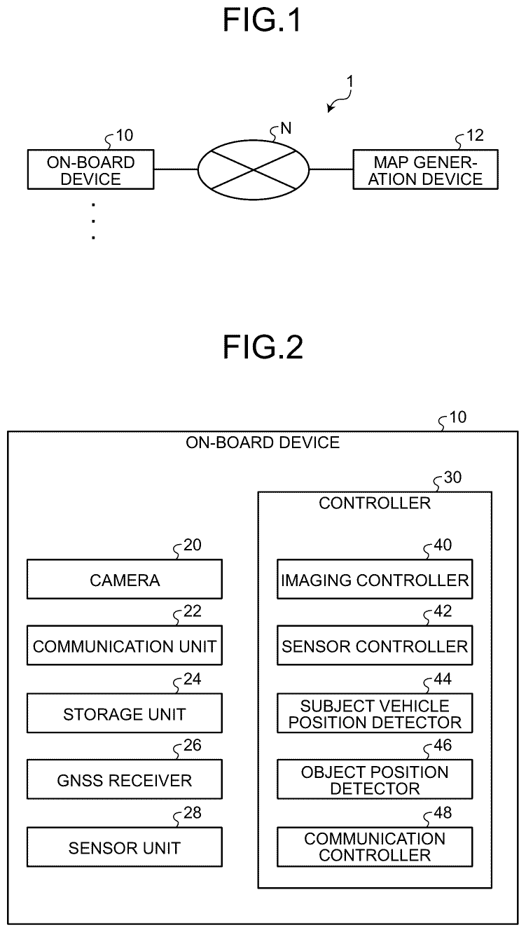

Using FIG. 1, a map generation system according to the first embodiment will be described. FIG. 1 is a diagram for describing an example of a configuration of a map generation system according to a first embodiment.

As illustrated in FIG. 1, a map generation system 1 includes a plurality of on-board devices 10 and a map generation device 12. The on-board devices 10 and the map generation device 12 are connected via a network N such that they are able to communicate with each other. The map generation system 1 is a system in which the map generation device 12 increases priority of accurate positional information based on positional information on a specific vehicle that is detected by the on-board device 10 mounted on a vehicle and positional information on another vehicle and generates a dynamic map.

### On-Board Device

Using FIG. 2, an example of a configuration of the on-board device according to the first embodiment will be described. FIG. 2 is a block diagram illustrating the example of the configuration of the on-board device according to the first embodiment.

As illustrated in FIG. 2, the on-board device 10 includes a camera 20, a communication unit 22, a storage unit 24, a GNSS (Global Navigation Satellite System) receiver 26, a sensor unit 28, and a controller 30. The on-board device 10 is mounted on a vehicle. The on-board device 10 detects positional information on a subject vehicle and positional information on surrounding objects around the subject vehicle containing positional information on a surrounding vehicle around the subject vehicle. The on-board device 10 transmits a result of detecting the positional information on the subject vehicle and the positional information on the surrounding objects around the subject vehicle to the map generation device 12.

The camera 20 is a camera that captures images of the surroundings of the vehicle. The camera 20 is, for example, a camera that captures moving images at a given frame rate. The camera 20 may be a monocular camera or a stereo camera. The camera 20 may be a single camera or a group of a plurality of cameras. For example, the camera 20 includes a front camera that captures a front view with respect to the vehicle, a right-side camera that captures a right-side view with respect to the vehicle, a left-side camera that captures a left-side view with respect to the vehicle, and a rear camera that captures a rear view with respect to the vehicle. The camera 20, for example, keeps capturing images of the surroundings of the vehicle while the vehicle is operating.

The communication unit 22 executes communication between the on-board device 10 and an external device. The communication unit 22 executes communication, for example, with the map generation device 12. The communication unit 22 is realized using a communication module that performs communication according to communication standards, such as 4G (4th Generation) and 5G (5th Generation).

The storage unit 24 stores various types of information. The storage unit 24 stores information, such as content of arithmetic operations by the controller 30 and programs. The storage unit 24, for example, includes at least any one of a main storage device, such as a random access memory (RAM) or a read only memory (ROM), and an external storage device, such as a hard disk drive (HDD).

The GNSS receiver 26 consists of a GNSS receiver that receives a GNSS signal from a GNSS satellite. The GNSS receiver 26 outputs a received GNSS signal to a subject vehicle position detector 44 of the controller 30.

The sensor unit 28 includes various types of sensors. The sensor unit 28 detects sensor information that makes it possible to identify a state of the vehicle on which the on-board device 10 is mounted. A sensor, such as a position sensor, a gyro sensor, or an acceleration sensor, is usable as the sensor unit 28. For example, a laser radar (for example, LIDAR: Laser Imaging Detection and Ranging) that detects a distance to a surrounding object, an infrared sensor including an infrared irradiator and a light receiving sensor, and a ToF (Time of Flight) sensor are exemplified as the position sensor. The position sensor may be realized by combining any ones of a gyro sensor, an acceleration sensor, a laser radar, an infrared sensor, and a ToF sensor or may be realized by combining all the sensors.

The controller 30 controls each unit of the on-board device 10. The controller 30 includes, for example, an information processing device, such as a central processing unit (CPU) or a micro processing unit (MPU), and a storage device, such as a RAM or a ROM. The controller 30, for example, may be realized using an integrated circuit, such as an application specific integrated circuit (ASIC) or a field programmable gate array (FPGA). The controller 30 may be realized using a combination of hardware and software.

The controller 30 includes an imaging controller 40, a sensor controller 42, the subject vehicle position detector 44, an object position detector 46, and a communication controller 48.

The imaging controller 40 controls the camera 20 and thereby causes the camera 20 to capture images of the surroundings of the subject vehicle. The imaging controller 40 acquires data of a video that the camera 20 is caused to capture.

The sensor controller 42 controls the sensor unit 28 and thus causes the sensor unit 28 to detect a state of the subject vehicle. The sensor controller 42 acquires sensor information representing the state of the subject vehicle that the sensor unit 28 is caused to detect.

The subject vehicle position detector 44 detects a position of the subject vehicle (the position of the on-board device 10) on which the on-board device 10 is mounted. Based on a GNSS signal that is received by the GNSS receiver 26, the subject vehicle position detector 44 detects a position of the subject vehicle on which the on-board device 10 is mounted. The subject vehicle position detector 44 may detect the position of the subject vehicle based on not only a GNSS signal but also sensor information that is acquired by the sensor controller 42. For example the subject vehicle position detector 44 detects the position of the subject vehicle based on a GNSS signal that is received by the GNSS receiver 26 and information of a gyro sensor and information of an acceleration sensor that are acquired by the sensor controller 42. The subject vehicle position detector 44, for example, calculates global coordinates of the subject vehicle based on the GNSS signal.

The object position detector 46 detects positional information on an object that is positioned around the subject vehicle, that is, positional information on a surrounding object. The object position detector 46 recognizes a surrounding object around the subject vehicle based on the video data that is acquired by the imaging controller 40 and measures the distance to the recognized object, thereby detecting positional information on the surrounding object around the subject vehicle. When the camera 20 is a monocular camera, the object position detector 46 detects the positional information on the surrounding object around the subject vehicle by using the SfM (Structure from Motion) method, or the like. The object position detector 46, for example, may analyze motions of the surrounding object around the subject vehicle by the SfM method and calculate a position of the object after an elapse of a given time. When the camera 20 is a stereo camera, the object position detector 46 detects the positional information on the surrounding object around the subject vehicle by using the principles of triangulation. The object position detector 46 detects the positional information on the surrounding object around the subject vehicle based on not only the video data but also the sensor information acquired by the sensor controller 42. For example, the object position detector 46 detects the positional information on the surrounding object around the subject vehicle based on the video data acquired by the imaging controller 40 and the information of the gyro sensor and the information of the acceleration sensor that are acquired by the sensor controller 42.

The object position detector 46, for example, detects positional information on a moving object that is moving around the subject vehicle. The object position detector 46, for example, detects positional information on a surrounding vehicle that is traveling around the subject vehicle. The object position detector 46, for example, detects positional information on a person who is moving around the subject vehicle. The object position detector 46, for example, detects positional information on a bicycle or a wheeled chair that is moving around the subject vehicle.

The communication controller 48 controls the communication unit 22 and thereby controls communication between the on-board device 10 and an external device. The communication controller 48 controls the communication unit 22 and thereby controls communication between the on-board device 10 and the map generation device 12. The communication controller 48, for example, transmits the positional information on the subject vehicle that is detected by the subject vehicle position detector 44 to the map generation device 12. The communication controller 48, for example, transmits the positional information on the surrounding object that is detected by the object position detector 46 to the map generation device 12.

### Map Generation Device

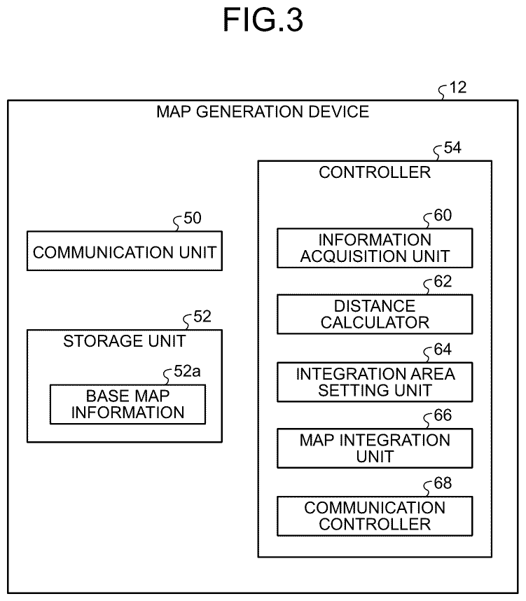

Using FIG. 3, an example of a configuration of the map generation device according to the first embodiment will be described. FIG. 3 is a diagram illustrating the example of the configuration of the map generation device according to the first embodiment.

As illustrated in FIG. 3, the map generation device 12 includes a communication unit 50, a storage unit 52, and a controller 54. The map generation device 12, for example, is realized using a server device that is arranged in a management center that manages the map generation system 1. The map generation device 12 is a device that generates a dynamic map based on the information that is acquired from the on-board devices 10.

The communication unit 50 executes communication between the map generation device 12 and an external device. The communication unit 50, for example, executes communication with the map generation device 12. The communication unit 50, for example, is realized using a communication module that performs communication according to a system, such as 4G (4th Generation), 5G (5th Generation), wireless LAN, or wired LAN.

The storage unit 52 stores various types of information. The storage unit 52 stores information, such as content of arithmetic operations by the controller 54 and programs. The storage unit 52 includes at least any one of a main storage device, such as a RAM or a ROM, and an external storage device, such as a HDD.

The storage unit 52 stores base map information 52a serving as a base for generating a dynamic map. In general, a dynamic map refers to a static map data obtained by mapping dynamic object data, on pedestrians, vehicles, and a traffic situation. The base map information 52a is accurate and static map data. The map data contains road information and construction information.

The controller 54 controls each unit of the map generation device 12. The controller 54 includes, for example, an information processing device, such as a CPU or a MPU, and a storage device, such as a RAM or a ROM. The controller 54, for example, may be realized using an integrated circuit, such as an ASIC or a FPGA. The controller 54 may be realized using a combination of hardware and software.

The controller 54 includes an information acquisition unit 60, a distance calculator 62, an integration area setting unit 64, a map integration unit 66, and a communication controller 68.

The information acquisition unit 60 acquires various types of information from the on-board device 10 via the communication unit 50. The information acquisition unit 60 acquires, as the positional information on the specific vehicle, the positional information on the subject vehicle that is detected by each of the subject vehicle position detector 44 of the on-board devices 10 via the communication unit 50. The information acquisition unit 60 acquires, via the communication unit 50, positional information on surrounding objects that is detected by the object position detector 46 of each of the on-board devices 10 and that contains positional information on a surrounding vehicle positioned around the specific vehicle on which the on-board device 10 is mounted.

The distance calculator 62 calculates a distance between the specific vehicle and the surrounding vehicle. The distance calculator 62 calculates a distance between the specific vehicle and the surrounding vehicle based on the positional information on the subject vehicle and the positional information on the surrounding vehicle around the specific vehicle that are acquired by the information acquisition unit 60.

The integration area setting unit 64 sets an integration area of integration into the base map information 52a. The integration area setting unit 64 sets an integration area based on the result of calculation by the distance calculator 62 and the area of detection by the specific vehicle. The area of detection of the surrounding object by the on-board device 10 is the maximum area in which the object position detector 46 is able to detect a surrounding object and, for example, is a circular area about the specific vehicle. The detection area may be transmitted from the on-board device 10 to the map generation device 12 or may be calculated by the map generation device 12. For example, the integration area is an area equal to or smaller than the area of detection of a surrounding object around the on-board device 10 that is mounted on the specific vehicle.

The map integration unit 66 integrates the positional information on the specific vehicle and the positional information on the surrounding object that are acquired from the on-board device 10 into the base map information 52a that is stored in the storage unit 52, thereby generating a dynamic map. The map integration unit 66 integrates the positional information on the surrounding object that is acquired from the on-board device 10 in the integration area that is set by the integration area setting unit 64 into the map.

The communication controller 68 controls the communication unit 50 and thereby controls communication between the map generation device 12 and an external device. The communication controller 68 controls the communication unit 50 and thereby controls communication between the map generation device 12 and the on-board device 10.

### Map Generation Device

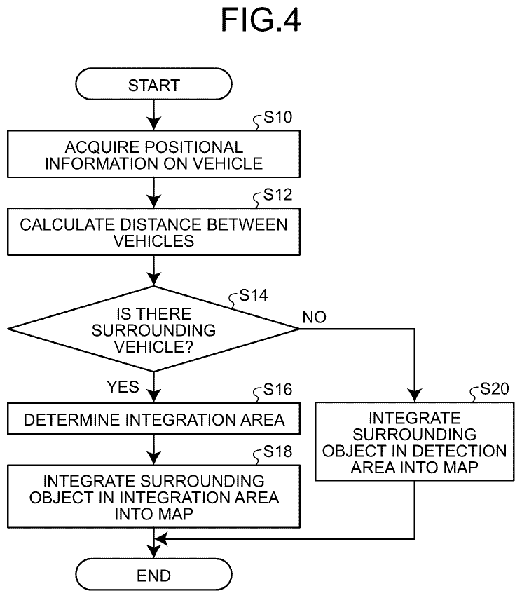

Using FIG. 4, a map generation process according to the first embodiment will be described. FIG. 4 is a flowchart illustrating a flow of the map generation process according to the first embodiment.

FIG. 4 illustrates the flow of the process of generating a dynamic map based on information that is acquired by the map generation device 12 from the on-board device 10.

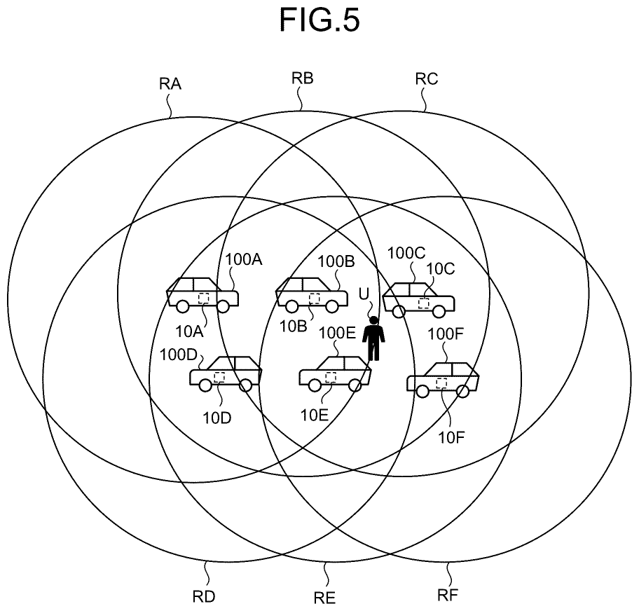

The information acquisition unit 60 acquires positional information on a vehicle (step S10). FIG. 5 is a diagram for describing a method of acquiring positional information on vehicles according to the first embodiment. As illustrated in FIG. 5, for example, a vehicle 100A, a vehicle 100B, a vehicle 100C, a vehicle 100D, a vehicle 100E, and a vehicle 100F are positioned. An on-board device 10A is mounted on the vehicle 100A. An on-board device 10B is mounted on the vehicle 100B. An on-board device 10C is mounted on the vehicle 100C. An on-board device 10D is mounted on the vehicle 100D. An on-board device 10E is mounted on the vehicle 100E. An on-board device 10F is mounted on the vehicle 100F. The on-board device 10A, the on-board device 10B, the on-board device 10C, the on-board device 10D, the on-board device 10E, and the on-board device 10F have the same configuration as that of the on-board device 10 illustrated in FIG. 2. A detection area RA represents an area of detection of surrounding objects around the on-board device 10A. A detection area RB represents an area of detection of surrounding objects around the on-board device 10B. A detection area RC represents an area of detection of surrounding objects around the on-board device 10C. A detection area RD represents an area of detection of surrounding objects around the on-board device 10D. A detection area RE represents an area of detection of surrounding objects around the on-board device 10E. A detection area RF represents an area of detection of surrounding objects around the on-board device 10F. In this case, the information acquisition unit 60 acquires positional information on the vehicle 100A that is detected by the on-board device 10A from the on-board device 10A. The information acquisition unit 60 acquires positional information on the vehicle 100B that is detected by the on-board device 10B from the on-board device 10B. The information acquisition unit 60 acquires positional information on the vehicle 100C that is detected by the on-board device 10C from the on-board device 10C. The information acquisition unit 60 acquires positional information on the vehicle 100D that is detected by the on-board device 10D from the on-board device 10D. The information acquisition unit 60 acquires positional information on the vehicle 100E that is detected by the on-board device 10E from the on-board device 10E. The information acquisition unit 60 acquires positional information on the vehicle 100F that is detected by the on-board device 10F from the on-board device 10F. The process then moves to step S12.

The distance calculator 62 calculates a distance between vehicles (step S12). FIG. 5 will be referred to again. The distance calculator 62 calculates distances each between ones of the vehicle 100A, the vehicle 100B, the vehicle 100C, the vehicle 100D, the vehicle 100E, and the vehicle 100F based on the positional information on the vehicles 100A to 100F that is acquired by the information acquisition unit 60. The process then moves to step S14. The distance calculator 62 determines whether there is a surrounding vehicle (step S14). Specifically, based on the distances between vehicles that are calculated at step S12, the distance calculator 62 determines that there is a surrounding vehicle when any vehicle serves as a specific vehicle and there is another vehicle in a position within a predetermined given distance. The given distance is an area of detection by the on-board device 10 that is mounted on the vehicle. The given distance may be set freely by the user. For example, when a vehicle is positioned within the area of detection by the on-board device 10, it may be determined that there is a surrounding vehicle. When it is determined that there is a surrounding vehicle (YES at step S14), the process moves to step S16. When it is not determined that there is a surrounding vehicle (NO at step S14), the process moves to step S20.

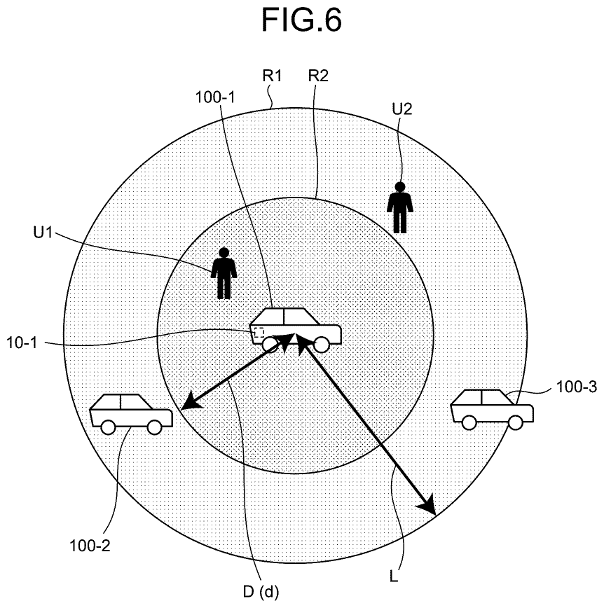

When YES is determined at step S14, the integration area setting unit 64 sets an integration area of integration into the base map information 52a (step S16). FIG. 5 will be referred to again. For example, in the case illustrated in FIG. 5, a person U is positioned within the detection area RA, the detection area RB, the detection area RC, the detection area RD, the detection area RE, and the detection area RF. In this case, because it is necessary to integrate the positional information on the person U that is transmitted from the on-board devices 10A to 10F, for example, there is a possibility that a process for determining priority of an on-board device will be complicated. For example, when only the positional information that is detected by the on-board device 10A with a long distance from the person U is used, there is a possibility that accuracy of the position of the person U that is integrated into the base map information 52a will lower. For this reason, according to the first embodiment, when there is a surrounding vehicle, an integration area is set. FIG. 6 is a diagram for describing a method of setting an integration area according to the first embodiment.

FIG. 6 illustrates an example of the method of setting an area of integration of a surrounding object that is detected by an on-board device 10-1 that is mounted on a vehicle 100-1. A detection area R1 represents an area of detection of surrounding objects by the on-board device 10-1. In other words, the on-board device 10-1 detects a person U1, a person U2, a vehicle 100-2, and a vehicle 100-3.

A distance L denotes a radius of the detection area R1. In this case, the integration area setting unit 64 sets a circular area having a radius d given by Equation (1) for an integration area R2 below.

$$d = a \times L \qquad ( 1 )$$

In Equation (1), a is any coefficient that is given in the range 0<a≤1. In other words, the integration area setting unit 64 sets any circular area having a radius equal to or shorter than the distance L for the integration area. The vehicle 100-2 and the vehicle 100-3 are positioned as surrounding vehicles around the vehicle 100-1. The surrounding vehicle that is in the closest position to the vehicle 100-1 is the vehicle 100-2. A distance D denotes a distance from the vehicle 100-1 to the vehicle 100-2 in a straight line. In this case, it is possible to calculate a by Equation (2) below and the distance D is the distance between the specific vehicle and the surrounding vehicle that is the closest to the specific vehicle.

$$a = D / L \qquad ( 2 )$$

Furthermore, a distance d may be set at a distance equal to or shorter than the distance to the surrounding vehicle that is the closest to the specific vehicle. The distance d may be set at a half distance of the distance to the surrounding vehicle that is the closest to the specific vehicle. Setting the distance d at a distance equal to or shorter than the distance to the surrounding vehicle that is the closest to the specific vehicle makes it possible to facilitate determination on weighting in integrating data and eliminate missing areas on which data should be integrated.

In the example illustrated in FIG. 6, the person u1, the person u2, the vehicle 100-2, and the vehicle 100-3 are contained as surrounding objects in the detection area R1. On the other hand, only the person U1 is contained as a surrounding object in the integration area R2. In this case, only the positional information on the person U1 that is positioned in the integration area R2 is integrated into the base map information 52a. Only the surrounding object in a position close to the vehicle 100-1 is integrated into the base map information 52a and accordingly accuracy of the dynamic map increases. The process then moves to step S18.

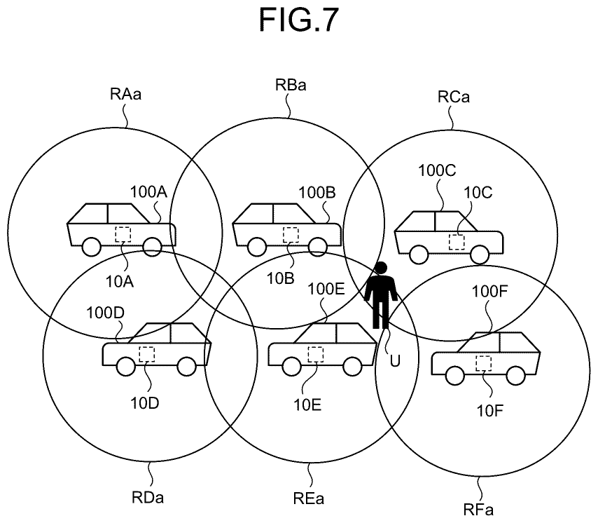

The map integration unit 66 integrates a surrounding object in an integration area that is set by the integration area setting unit 64 into a map (step S18). FIG. 7 is a diagram for describing a method of integrating the surrounding object in the integration area into the map according to the first embodiment. An integration area RAa is an area of integration of a surrounding object that is detected by the on-board device 10A and is set by the integration area setting unit 64. An integration area RBa is an area of integration of a surrounding object that is detected by the on-board device 10B and is set by the integration area setting unit 64. An integration area RCa is an area of integration of a surrounding object that is detected by the on-board device 10C and is set by the integration area setting unit 64. An integration area RDa is an area of integration of a surrounding object that is detected by the on-board device 10D and is set by the integration area setting unit 64. An integration area REa is an area of integration of a surrounding object that is detected by the on-board device 10E and is set by the integration area setting unit 64. An integration area RFa is an area of integration of a surrounding object that is detected by the on-board device 10F and is set by the integration area setting unit 64. In the example illustrated in FIG. 7, the person U is positioned in the integration area RCa and the integration area REa. In this case, the map integration unit 66 integrates the positional information on the person U that is detected by the on-board device 10C and the on-board device 10E in positions close to the user U into the base map information 52a. This makes it possible to increase accuracy of the dynamic map.

The map integration unit 66 sometimes integrates positional information of one object from a plurality of the on-board devices 10 into the base map information 52a. In this case, the positional information on the object would differ in each of the on-board devices 10. For example, there is a possibility that a difference will occur between the positional information on the person U that is detected by the on-board device 10C and the positional information on the person U that is detected by the on-board device 10E. In this case, the map integration unit 66 integrates, as the positional information on the person U, an intermediate position between the positional information on the person U that is detected by the on-board device 10C and the positional information on the person U that is detected by the on-board device 10E into the base map information 52a. Furthermore, in another example, the map integration unit 66 compares the distance between the vehicle 100C and the person U (for example, detected by the on-board device 10C) and the distance between the vehicle 100E and the person U (for example, detected by the on-board device 10E) and integrates a position closer to the on-board device 10 positioned closer to the person U as the positional information on the person U into the base map information 52a.

The map integration unit 66 determines priority of the on-board device 10C and the on-board device 10E and integrates the positional information on the person U that is detected by the prior on-board device into the base map information 52a. For example, the distance between the vehicle 100C and the person U and the distance between the vehicle 100E and the person U are compared with each other and the on-board device 10 closer to the person U is prior. In this case, the map integration unit 66 only has to integrate the positional information that is obtained from the two on-board devices into the base map information and this facilitates determination on priority of the on-board devices and reduces the load of the process. Then, the process in FIG. 4 ends.

When NO is determined at step S14, the map integration unit 66 integrates a surrounding object in the area of detection into the map (step S20). Specifically, the map integration unit 66 integrates the positional information on the surrounding object that is detected by the on-board device of the subject vehicle into the base map information. Then, the process in FIG. 4 ends.

As described above, in the first embodiment, an integration area for integration into a map is set based on the distances each between a vehicle and a surrounding vehicle. Accordingly, the first embodiment enables generation of an accurate dynamic map.

### Modification 1 of First Embodiment

Modification 1 of the first embodiment will be described. In the first embodiment, an integration area is set based on the distances each between a vehicle and a surrounding vehicle; however, the present disclosure is not limited to this.

The integration area setting unit 64, for example, may make a setting based on the number of vehicles per unit of area. The integration area setting unit 64, for example, sections a map into 100-square-meter blocks and, when n denotes the number of vehicles in a block, it is possible to set a radius d of a circular area as in Equation (3) below.

$$d = 1000 / n \qquad ( 3 )$$

For example, when there are 100 vehicles in a 100-square-meter block on a map, d is 10 meters and positional information on a surrounding object that is positioned in a circular area about the vehicle having a radius of 10 meters is integrated into the map and thus a dynamic map is generated. Modification 1 of the first embodiment thus makes it possible to generate an accurate dynamic map easily.

### Modification 2 of First Embodiment

Modification 2 of the first embodiment will be described below. In the first embodiment, the integration area is described as the circular area having the radius d; however, the present disclosure is not limited to this. For example, the integration area setting unit 64 may set, for an integration area, an area around a vehicle that is long forward in a direction in which the vehicle travels, that is, has a wide forward area, and that is short sideward and backward, that is, has a narrow area. For example, the integration area setting unit 64 sets, for the integration area, an area whose forward area is set at a distance between a specific vehicle and a surrounding vehicle that is the closest to the specific vehicle and whose sideward and rearward areas are shorter than the distance between the specific vehicle and the surrounding vehicle that is the closest to the specific vehicle. In general, information on the forward area is important to on-board devices and therefore accuracy in detecting surrounding objects positioned forward is often high. For this reason, by making the forward integration area long, Modification 2 of the first embodiment makes it possible to generate an accurate dynamic map.

### Modification 3 of First Embodiment

Modification 3 of the first embodiment will be described. In the first embodiment, the map generation device 12 sets an integration area and the on-board device 10 transmits the positional information on all the surrounding objects in the detection area to the map generation device 12; however, the present disclosure is not limited to this. For example, when it is possible to know an integration area previously based on positional information on each vehicle, the on-board device 10 may narrow the detection area to the integration area. In this case, the map generation device 12 may transmit information on the integration area to the on-board device 10 or the on-board device 10 may calculate an integration area based on a result of detection by the object position detector 46. Accordingly, the on-board device 10 transmits positional information on a surrounding object positioned in the integration area narrower than the detection area to the map generation device 12. Accordingly, in Modification 3 of the first embodiment, because less information is transmitted from the on-board device 10 to the map generation device 12, it possible to reduce the load of communication.

### Second Embodiment

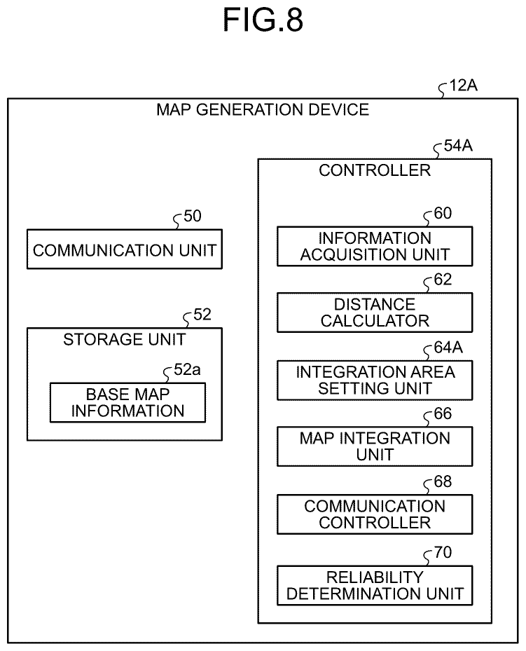

A second embodiment of the present disclosure will be described. FIG. 8 is a block diagram illustrating an example of a configuration of a map generation device according to the second embodiment.

As illustrated in FIG. 8, a map generation device 12A is different from the map generation device illustrated in FIG. 3 in that a controller 54A includes a reliability determination unit 70.

Information on each of a plurality of on-board devices 10 differs depending on the performance of each of cameras and sensors of the on-board devices 10 and therefore the reliability determination unit 70 determines reliability representing a degree of accuracy of each of the on-board devices 10 in detecting a surrounding object. Based on a degree of agreement between positional information on a vehicle that is detected by the on-board device 10 mounted on the vehicle and positional information on a vehicle that is detected by the on-board device 10 mounted on a surrounding vehicle around the vehicle, the reliability determination unit 70 determines reliability of the on-board device 10 mounted on the surrounding vehicle in detecting a surrounding object. For example, when the degree of agreement of positional information on a specific vehicle that is detected by the on-board device 10 mounted on a surrounding vehicle with positional information on the specific vehicle that is detected by the on-board device 10 mounted on the specific vehicle is higher, the reliability determination unit 70 determines that the reliability of the on-board device 10 mounted on the surrounding vehicle in detecting a surrounding object is higher. This is because accuracy of the on-board device 10 in detecting a position of a specific vehicle based on a GNSS signal is higher than accuracy in detecting a position of a surrounding vehicle based on video data.

The reliability of the on-board device 10 can vary dynamically due to not only performance of the device but also a direction of sunlight, brightness of the surroundings, a traveling speed of the vehicle, weather, and a stain of a lens of the camera 20, etc., during travel of the vehicle. For this reason, the reliability determination unit 70 preferably determines reliability each time positional information is acquired from the on-board device 10. In other words, the reliability determination unit 70 preferably keeps determining reliability of the on-board device 10.

For example, when the load of a process of determining reliability is heavy, the reliability determination unit 70 may determine reliability of the on-board device 10 at given timing. For example, when the vehicle stops because of a red light or a traffic jam, the reliability determination unit 70 may determine reliability of the on-board device 10. Determining reliability of the on-board device 10 at given timing makes it possible to reduce the load of the process.

Based on reliability of the on-board device 10 that is determined by the reliability determination unit 70, a integration area setting unit 64A sets an integration area of integration into the base map information 52a. The integration area setting unit 64A sets the integration area wider for the on-board device 10 with higher reliability and sets the integration area narrower for the on-board device 10 with lower reliability.

### Reliability Determination Process

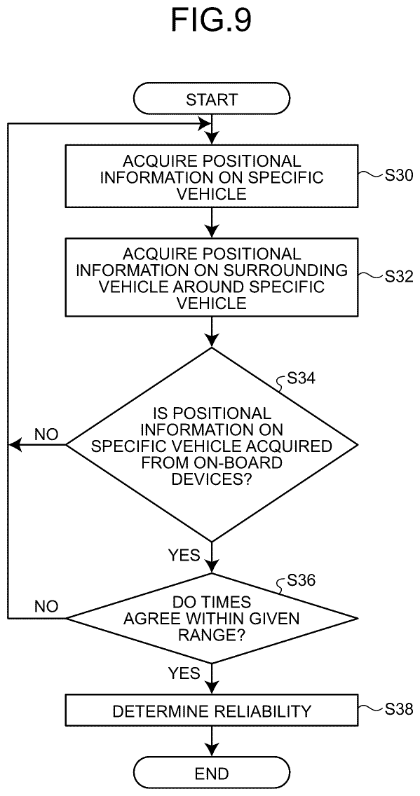

Using FIG. 9, a reliability determination process performed by the on-board device according to the second embodiment will be described. FIG. 9 is a flowchart illustrating a flow of the reliability determination process performed by the on-board device according to the second embodiment.

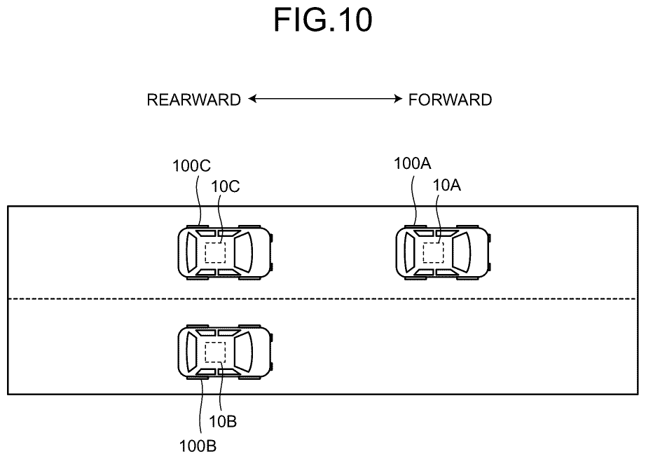

The information acquisition unit 60 acquires positional information on a vehicle (step S30). FIG. 10 is a diagram for describing a method of acquiring vehicle information according to the second embodiment. In FIG. 10, a direction denoted with “forward” is the travel direction of the vehicle and the direction denoted with “rearward” is a direction opposite to the travel direction of the vehicle. As illustrated in FIG. 10, for example, the vehicle 100A, the vehicle 100B, and the vehicle 100C are traveling on a road. The on-board device 10A is mounted on the vehicle 100A. The on-board device 10B is mounted on the vehicle 100B. The on-board device 10C is mounted on the vehicle 100C. Each of the on-board device 10A, the on-board device 10B, and the on-board device 10C can have different accuracy in detecting a position of a specific vehicle and in detecting a position of a surrounding vehicle. In this case, the information acquisition unit 60 acquires positional information on the vehicle 100A that is detected by the on-board device 10A from the on-board device 10A. The information acquisition unit 60 acquires positional information on the vehicle 100B that is detected by the on-board device 10B from the on-board device 10B. The information acquisition unit 60 acquires positional information on the vehicle 100C that is detected by the on-board device 10C from the on-board device 10C. The process then moves to step S32.

The information acquisition unit 60 acquires positional information on surrounding vehicles around the vehicle (step S32). FIG. 10 will be referred to again. The information acquisition unit 60 acquires positional information on the vehicle 100B and the vehicle 100C that is acquired by the on-board device 10A from the on-board device 10A. The information acquisition unit 60 acquires positional information on the vehicle 100A and the vehicle 100C that is acquired by the on-board device 10B from the on-board device 10A. The information acquisition unit 60 acquires positional information on the vehicle 100A and the vehicle 100B that is acquired by the on-board device 10C from the on-board device 10A. The process then moves to step S34.

In the flowchart illustrated in FIG. 9, the positional information on the specific vehicle and the positional information on the surrounding vehicle around the specific vehicle need not necessarily be acquired from a plurality of the on-board devices 10 at step S30 and step S32.

The reliability determination unit 70 determines whether positional information on the specific vehicle is acquired from the on-board devices that are mounted on a plurality of surrounding vehicles (step S34). FIG. 5 will be referred to again. As for the vehicle 100A, the reliability determination unit 70 determines whether positional information on the vehicle 100A is acquired from both the on-board device 10B and the on-board device 10C. As for the vehicle 100B, the reliability determination unit 70 determines whether positional information on the vehicle 100B is acquired from both the on-board device 10A and the on-board device 10C. As for the vehicle 100C, the reliability determination unit 70 determines whether positional information on the vehicle 100C is acquired from both the on-board device 10A and the on-board device 10B. When it is determined that positional information on the specific vehicle is acquired from the on-board devices that are mounted on a plurality of the surrounding vehicles (YES at step S34), the process moves to step S36. When it is not determined that positional information on the specific vehicle is acquired from the on-board devices that are mounted on a plurality of the surrounding vehicles (NO at step S34), the process moves to step S30.

When YES is determined at step S34, the reliability determination unit 70 determines whether the time at which the positional information on the specific vehicle is detected and the time at which the positional information on the specific vehicle is detected by the surrounding vehicle around the specific vehicle agree within a given range (step S36). Specifically, the reliability determination unit 70 determines whether the time at which the on-board device 10A detects the vehicle 100A and the time at which each of the on-board device 10B and the on-board device 10C detects the vehicle 100A agree within the given range. The reliability determination unit 70 determines whether the time at which the on-board device 10B detects the vehicle 100B and the time at which each of the on-board device 10A and the on-board device 10C detects the vehicle 100B agree within the given range. The reliability determination unit 70 determines whether the time at which the on-board device 10C detects the vehicle 100C and the time at which each of the on-board device 10A and the on-board device 10B detects the vehicle 100C agree within the given range. The given range may change according to the traveling state of the vehicle. For example, when all the vehicles 100A to 100C stop, the given range is set wide, for example, at few seconds. For example, when any one of the vehicles 100A to 100C travels at high speed, the given range is set narrow, for example, at few milliseconds. When it is determined that the time at which the positional information on the specific vehicle is detected and the time at which the positional information on the specific vehicle is detected by the surrounding vehicle around the specific vehicle agree (YES at step S36), the process moves to step S38. When it is not determined that the time at which the positional information on the specific vehicle is detected and the time at which the positional information on the specific vehicle is detected by the surrounding vehicle around the specific vehicle agree (NO at step S36), the process moves to step S30.

Note that, when it is not determined that the time at which the positional information on the specific vehicle is detected and the time at which the positional information on the specific vehicle is detected by the surrounding vehicle around the specific vehicle agree (NO at step S36) and a process of predicting a position of the specific vehicle and a position of the surrounding vehicle based on the travel speed of the vehicle, etc., is performed, the process may move to step S38 without moving to step S30.

When YES is determined at step S36, the reliability determination unit 70 determines reliability of the on-board devices (step S38). The reliability determination unit 70 determines reliability of each on-board device based on the degree of agreement between the positional information on the specific vehicle that is detected by the on-board device mounted on the specific vehicle and the positional information on the specific vehicle that is detected by the on-board device mounted on the surrounding vehicle. Specifically, when the degree of agreement between the positional information on the specific vehicle that is detected by the on-board device mounted on the specific vehicle and the positional information on the specific vehicle that is detected by the on-board device mounted on the surrounding vehicle is higher, the reliability determination unit 70 sets the reliability higher. When the degree of agreement between the positional information on the specific vehicle that is detected by the on-board device mounted on the specific vehicle and the positional information on the specific vehicle that is detected by the on-board device mounted on the surrounding vehicle is lower, the reliability determination unit 70 sets the reliability lower. Then the process in FIG. 9 ends.

### Map Generation Process

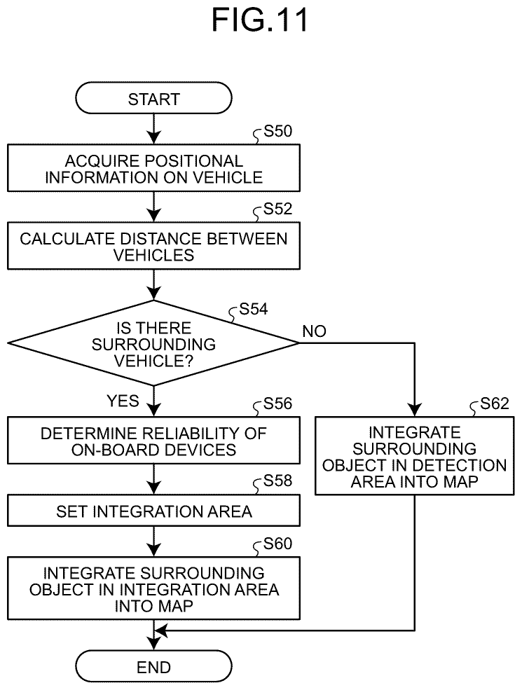

Using FIG. 11, a map generation process according to the second embodiment will be described. FIG. 11 is a flowchart illustrating a flow of the map generation process according to the second embodiment.

The steps S50 to S54 are the same as the steps S10 to step S14 illustrated in FIG. 4, respectively, and thus description thereof will be omitted.

When Yes is determined at step S54, the reliability determination unit 70 determines reliability of the on-board devices (step S56). Specifically, the reliability determination unit 70 determines reliability of the on-board devices 10A to 10F of the vehicles 100A to 100F (refer to FIG. 5) according to the process illustrated in FIG. 9. Then the process moves to step S58.

The integration area setting unit 64A sets an integration area of integration into the base map information 52a based on the reliability of the on-board device 10 that is determined by the reliability determination unit 70 (step S58). Specifically, the integration areas RAa to RFa of the on-board devices 10A to 10F (refer to FIG. 7) are set such that, the higher the reliability of the on-board device 10 is, the wider the integration area is and, the lower the reliability of the on-board device 10 is, the narrower the integration area is. The process then moves to step S60.

The steps S60 and S62 are the same as the steps S18 and to step S20 illustrated in FIG. 4, respectively, and thus description thereof will be omitted. Note that, at step S60, the map integration unit 66 may determine priority based on reliability of the on-board device 10 that is determined by the reliability determination unit 70 and integrate a surrounding object in the integration area that is set by the integration area setting unit 64A, which is the surrounding object detected by the prior on-board device.

As described above, in the second embodiment, an integration area for integration of positional information on a surrounding object is set according to the reliability of each on-board device. Accordingly, the second embodiment enables generation of an accurate map easily according to reliability.

Each component of each of the devices illustrated in the drawings is a functional idea and need not necessarily be configured physically as illustrated in the drawings. In other words, specific modes of each device are not limited to those illustrated in the drawings and all or part of the device may be functionally or physically distributed or integrated in any unit according to various types of load and usage. Note that the configuration caused by the distribution and integration may be made dynamically.

The present disclosure contributes to realization of “Build infrastructure for industrialization and innovation” and includes items that contribute to creation of values by IoT solutions.

According to the disclosure, it is possible to generate an accurate map easily.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A map generation device comprising:
an information acquisition unit that acquires positional information on a specific vehicle and positional information on a surrounding vehicle that is positioned around the specific vehicle from on-board devices that are arranged respectively on the specific vehicle and the surrounding vehicle, respectively;
a distance calculator that calculates a distance between the specific vehicle and the surrounding vehicle based on the positional information on the specific vehicle and the positional information on the surrounding vehicle;
an integration area setting unit that sets an integration area of integration into a map based on a result of calculating the distance and an area of detection by the specific vehicle; and
a map integration unit that integrates an information on the surrounding object that is acquired from the on-board device in the integration area into a map.

2. The map generation device according to claim 1, wherein the integration area setting unit sets, for the integration area, a circular area about the specific vehicle having a radius equal to or smaller than a distance to the surrounding vehicle that is the closest to the specific vehicle.

3. The map generation device according to claim 1, wherein the integration area setting unit sets, for the integration area, an area about the specific vehicle in which a forward area in a travel direction of the specific vehicle extends differently from sideward and backward areas.

4. The map generation device according to claim 1, further comprising:
a reliability determination unit that determines reliability of each of the on-board devices based on a degree of agreement between the positional information on the specific vehicle that is detected by the on-board device that is mounted on the specific vehicle and the positional information on the specific vehicle that is detected by the on-board device that is mounted on the surrounding vehicle,
wherein the integration area setting unit sets the integration area wide for the on-board device whose reliability is high and sets the integration area narrow for the on-board device whose reliability is low.

5. The map generation device according to claim 4,
wherein the reliability determination unit that the reliability determination unit sets the reliability higher when the degree of agreement between the positional information on the specific vehicle that is detected by the on-board device mounted on the specific vehicle and the positional information on the specific vehicle that is detected by the on-board device mounted on the surrounding vehicle is higher, and sets the reliability lower when the degree of agreement between the positional information on the specific vehicle that is detected by the on-board device mounted on the specific vehicle and the positional information on the specific vehicle that is detected by the on-board device mounted on the surrounding vehicle is lower.

6. The map generation device according to claim 1,
wherein the integration area setting unit sets an integration area for mapping a dynamic object data based on the result of calculation by the distance calculator and the area of detection by the specific vehicle, and
the integration area setting unit maps the surrounding object acquired from the in-vehicle device in the integration area as the dynamic object data to the static map data.

7. A map generation method comprising:
acquiring positional information on a specific vehicle and positional information on a surrounding vehicle that is positioned around the specific vehicle from on-board devices that are arranged respectively on the specific vehicle and the surrounding vehicle, respectively;
calculating a distance between the specific vehicle and the surrounding vehicle based on the positional information on the specific vehicle and the positional information on the surrounding vehicle;
setting an integration area of integration into a map based on a result of calculating the distance and an area of detection by the specific vehicle; and
integrating an information on the surrounding object that is acquired from the on-board device in the integration area into a map.
